(19) United States
(12) Patent Application Publication
(10) Pub. No.: US 2014/0088971 A1
(43) Pub. Date: Mar. 27, 2014

(54) System And Method For Voice Operated Communication Assistance

(71) Applicant: Michael D. Metcalf, Lake Forest, CA (US)

(72) Inventor: Michael D. Metcalf, Lake Forest, CA (US)

(21) Appl. No.: 13/970,958

(22) Filed: Aug. 20, 2013

Related U.S. Application Data
(60) Provisional application No. 61/691,254, filed on Aug. 20, 2012.

(51) Int. Cl. G10L 21/00; H04M 7/00

(52) U.S. Cl. CPC G10L 21/00; H04M 7/006
USPC 704/270.1

(57) ABSTRACT

A system and method for voice operated communication assistance. Embodiments of the invention may include detecting a predetermined command from a first user making a call on a communication device; redirecting the call to a hosted application; and notifying the first user that the hosted application is ready to accept a command, receiving data from a second user; and converting the data from the second user to a voice signal and sending the voice signal to the first user. The commands may be a voice commands.

### CROSS-REFERENCE TO RELATED APPLICATION

This application claims the benefit of priority to U.S. Patent Application No. 61/691,254, filed Aug. 20, 2012, the contents of which are fully incorporated herein by reference.

### BACKGROUND

Telephone systems for many years have employed assistants to help users of the systems access and utilize the systems effectively. For example, traditional analog telephone systems typically give users the opportunity to dial “0” to reach an operator if a user should need assistance in communicating with another telephone user, whether a business or an individual, such as for making a collect call, accessing directory assistance, and the like. Such assistance has typically been very limited.

With access to the Internet now being widespread, some companies offer Voice over Internet Protocol (VoIP) adapters, which allow residential analog telephone system customers to utilize the Internet for making phone calls by having users plug their existing analog telephones into the VoIP adapter. The adapter itself may then be connected to the Internet. The VoIP adapter converts the analog voice call into a data packet which is then transmitted over the Internet as data rather than voice. Eventually, the data is converted back into an analog voice signal so that a party making the call can talk to the party receiving the call. Such VoIP adapters have helped consumers lower their phone bills. However, there is typically no assistance offered to a user of a VoIP adapter when using the VoIP adapter to place a telephone call.

### SUMMARY OF THE INVENTION

A method for voice operated communication assistance may include detecting a predetermined command from a first user making a call on a communication device; redirecting the call to a hosted application; and notifying the first user that the hosted application is ready to accept a command. The method may further include receiving data from a second user; and converting the data from the second user to a voice signal and sending the voice signal to the first user. According to an embodiment of the present invention, the command may be a voice command. The voice command may direct the hosted application to assist the user with communication. According to another embodiment of the present invention, the data may be a text message. The method may further include loading information into the hosted application, wherein the information is associated with the user. The information may include social network information related to the user.

According to an embodiment of the present invention, a system for voice operated communication assistance may include a network adapter for detecting a predetermined command from a user making a call on a communication device and a hosted application for receiving the call. Embodiments of the present invention may be configured such that the network adapter may redirect the call to the hosted application and the hosted application may notify the user that the hosted application is ready to accept a voice operated communication assistance command. The predetermined command may be a voice command. According to an embodiment of the present invention, the communication device may be a mobile telephone or may be an analog telephone. The hosted application may be configured to assist the user with communication, and may be configured to deliver a text message to the user.

### BRIEF DESCRIPTION OF THE DRAWINGS

FIG. 1 shows a block diagram of a voice operated communication assistance system according to an embodiment of the present invention.

FIG. 2 shows a method for voice operated communication assistance according to an embodiment of the present invention.

FIG. 3 shows another method for a voice operated communication assistance according to an embodiment of the present invention.

FIG. 4 shows another method for a voice operated communication assistance according to an embodiment of the present invention.

### DETAILED DESCRIPTION

In the following description of preferred embodiments, reference is made to the accompanying drawings which form a part hereof, and in which are shown by way of illustration specific embodiments in which the invention may be practiced. It is to be understood that other embodiments may be utilized without departing from the scope of the present invention.

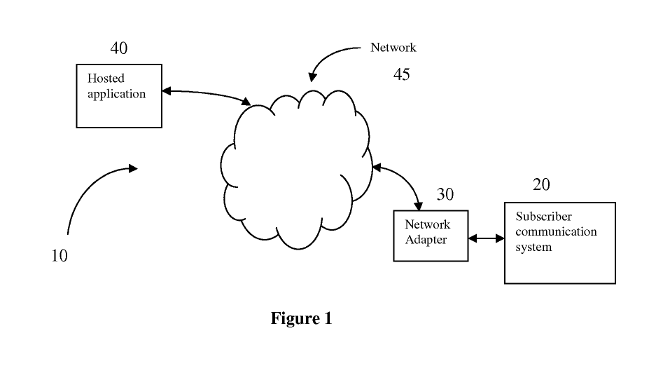

A system for voice operated communication assistance 10 according to an embodiment of the present invention is shown in FIG. 1. FIG. 1 includes, for example, a subscriber communication device 20, a network adapter 30 and a hosted application 40. The subscriber communication device 20, the network adapter 30 and the hosted platform 40 may be connected to a network 45. The network 45 may be a public or private network, a local area network or a wide area network, or may be the Internet.

The subscriber communication device 20 may be any type of communication device into which a subscriber may communicate with another person or another device. Alternatively, the subscriber communication device 20 may be a communication system. For example, according to an embodiment of the present invention, the subscriber communication device 20 may be a traditional analog telephone system. Alternatively, the subscriber communication device 20 may be a simple residential telephone, a cordless phone, a mobile telephone, a smartphone, or any other communication device into which can be spoken voice signals or voice commands.

According to the embodiment of the invention shown in FIG. 1, the subscriber communication device 20 may be communicatively coupled to the network adapter 30. The network adapter 30 may be a Voice over Internet protocol (VoIP) adapter, configured to accept voice or analog signals and convert such signals to data suitable for transmission over a data network. VoIP adapters are well-known in the art. The network adapter 30 is communicatively coupled to the network 45 such that the subscriber communication device 20, through the network adapter 30, may access the network 45.

The network adapter 30 may be configured so that it, upon receiving a predetermined command from the subscriber communication device 20, the network adapter 30 redirects a subscriber using the subscriber communication device 20 to the hosted application 40. The predetermined command could take a variety of forms. For example, if the subscriber communication device 20 is a mobile telephone, the predetermined command could take the form of a subscriber to the hosted application 40 by depressing the “0” key on the mobile telephone. In this way, the subscriber would be mimicking the “dial 0” protocol historically associated with traditional analog telephone systems when a user of such systems needed operator assistance. Alternatively, in another embodiment of the present invention, the subscriber communication device 20 may be configured such that the subscriber need only speak the words “dial zero” into the subscriber communication device 20 for the network adapter 30 to redirect the subscriber's call to the hosted application 40. According to an embodiment of the present invention, the network adapter 30 may be configured such that the subscriber communication device 20 is redirect to the hosted application 40 using session initiation protocol (SIP).

The hosted application 40 shown in FIG. 1 may be a software program that resides on a computer system. For example, the hosted application 40 may reside on a computer system having a processor coupled to a memory, storage, a network interface and an I/O interface. The processor may be or include one or more microprocessors as well as other logic circuits. The memory may include RAM, ROM, DRAM, SRAM and the like, and may include firmware, such as static data or fixed instructions, BIOS, system functions, configuration data, and other routines used during the operation of the processor. The memory may also provide a storage unit for data and instructions associated with applications and data handled by the processor. The storage unit provides non-volatile long term storage of data or instructions in the computer system. The storage unit may take the form of a disk, optical storage, SAN, tape, CD, DVD, or other reasonably high capacity addressable storage medium.

According to an embodiment of the present invention, the hosted application 40 may be implemented as a website resident on a server computer. For example, the server computer may be programmed such that the application generates a website available to subscribers over a network. According to an embodiment of the present invention, subscribers to the hosted application 40 may access the application hosted by the server computer via a website on the Internet.

The hosted application 40 may be configured such that it accepts users or subscribers. According to an embodiment of the present invention, subscribers may enroll with the hosted application 40 and enter information about themselves. Such information may include, for example, a contact list, an email address, social network account information, phone numbers and the like. For example, a subscriber may enter the account information for the user's TWITTER and FACEBOOK accounts so that the hosted application 40 will have this information readily available when the subscriber contacts the hosted application 40.

According to an embodiment of the present invention, the hosted application 40 may be configured such that when the network adapter 30 redirects the subscriber communication device 20 to the hosted application 40, the hosted application 40 connects to the subscriber communication device 20 via the network 45 and logs into the subscriber account. The hosted application 40 may log on to the subscriber account using a “caller ID,” “media access control (mac) ID,” or other identification mechanism associated with the subscriber communication device 20 as are well-known in the art.

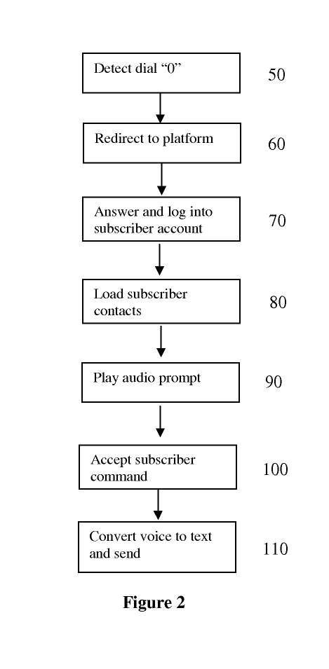

A method of voice operated communication assistance according to an embodiment of the present invention is shown in FIG. 2. In FIG. 2, while also referring back to FIG. 1, at step 50, the network adapter 30 detects a “dial 0” type of command entered by the subscriber. In other words, the subscriber has entered some type of predetermined command, with some physical act such as depressing the “0” key or a voice instruction or some other type of command, which has been detected by the network adapter 30 or by the subscriber communication device 20 connected the network adapter 30. According to an embodiment of the present invention, the subscriber may say “operator” or, for example, may say “VOICE ASSIST.” Upon receipt of this command, at step 60 the network adapter 30 redirects the call to the hosted application 40. At step 70, the hosted application 40 accepts the communication from the network adapter 30 and the subscriber communication device 20 and logs in to the subscriber account. At step 80, the hosted application 40 loads information associated with the subscriber, such as contact information, social networking account information, and the like. At step 90, the hosted application 40 sends a signal back to the subscriber communication device 20 to notify the subscriber that the hosted application 40 is now ready to accept a voice operated communication assistance command from the subscriber.

At step 100, the subscriber communication device 20 accepts a command from the user. Because the network adapter 30 has redirected the call to the hosted application 40, the command is sent to the hosted application 40. The hosted application 40 then takes the direction dictated by the command at step 110.

The command sent to the hosted application 40 may be any of numerous commands. For example, a subscriber may say “call” followed by any name in the subscribers address book to make calls without dialing. Alternatively, according to another embodiment of the present invention, a subscriber may say “send a text message” followed by any name in the subscriber's address book to send a text by voice without typing.

According to another embodiment of the present invention, a subscriber may say “read my email” or “reply to email” or “send a new email” or “copy or forward an email.” The subscriber may then listen to the subscriber's email messages, or reply to the subscriber's email messages, and the like, all using voice commands, without typing and without using a computer or smart phone.

According to another embodiment of the present invention, a subscriber may post to a social network, such as TWITTER or FACEBOOK, for example simply by entering or voicing the predetermined command to be redirected to the hosted application 40, then saying “post to TWITTER” or “post to FACEBOOK,” and then dictating a message. The hosted application 40 will then convert the message from voice into data and post the text into the social network site as if it had been typed by the subscriber.

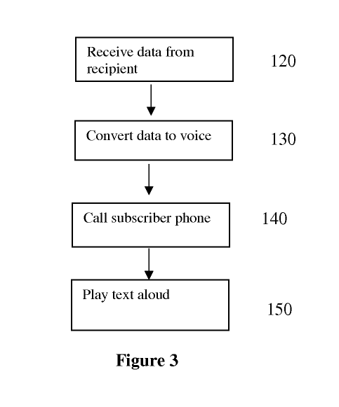

Another method of voice operated communication assistance according to an embodiment of the present invention is shown in FIG. 3. In FIG. 3, while also referring back to FIG. 1, at step 120, the hosted application 40 receives data from a recipient of the subscriber call. At step 130, the hosted application 40 converts the data into a voice signal. At step 140, the hosted application 40 calls the subscriber communication device 20 via the network 45 and the network adapter 30. When the subscriber answers the subscriber communication device 20, the hosted application 40 plays aloud the voice signal converted from the data received from the recipient so that the subscriber may hear it. In this way, embodiments of the present invention allow subscribers to send and receive text messages without a mobile phone, a personal computer, or the like.

According to an embodiment of the present invention, subscribers may say a voice command that causes the hosted application 40 to engage a live, human operator. For example, upon entering a predetermined command into the subscriber communication device 20 that causes the network adapter 30 to redirect the subscriber's call to the hosted application 40, the subscriber may say something like “live assist,” “live assistance please,” or the like. Upon receiving this command, the hosted application 40 connects the subscriber to a live operator. The live operator may be highly educated and may have access to a variety of tools, such as high speed Internet, for example, and may be capable of helping the subscriber with a variety of requests. For example, the live operator may help the subscriber with ordering food, renewing prescriptions, checking the weather, getting groceries delivered, scheduling a doctor appointment, getting medical advice and the like.

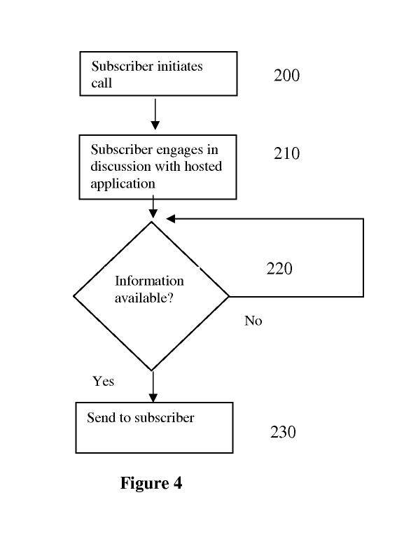

A method of voice operated communication assistance according to yet another embodiment of the present invention is shown in FIG. 4. In FIG. 4, a method of incorporating voice operated communication assistance with Internet search is shown. Embodiments of the present invention allow a subscriber to interact with the hosted platform 40 using voice communication so that enhanced content becomes available to the subscriber. For example, in FIG. 4, while also referring back to FIG. 1, at step 200, a subscriber may initiate a call using the subscriber communication device 20 and may give the subscriber communication device 20 a predetermined command that causes the network adapter 30 to direct the call to the hosted application 40.

At step 210, the subscriber may engage in a discussion with the hosted application 40, wherein the subscriber asks questions to or gives commands to the hosted application 40. The hosted application 40 may be configured so that, in turn, it responds to the subscriber's questions or commands. The response from the hosted application 40 may be a question for the subscriber or may be an action taken.

For example, according to an embodiment of the present invention, the subscriber may ask the hosted application 40, “What's for dinner?” In response, the hosted application 40 may be configured such that it responds by saying, “What kind of food would you like to eat?” The subscriber may then say, for example, “I'd like Italian food.” The hosted application 40 may then say, for example, “Do you want to cook or do you want to go out?” The subscriber may then say, “I'd like to cook.” The hosted application 40 may then say, “Do you want a recipe with chicken, veal, pasta, steak or just vegetables?” The subscriber may then respond with, “I'd like chicken.” The hosted application 40 may then say, “How about chicken marsala or chicken cacciatore?” The subscriber may then respond with, “I'd like chicken marsala.” The hosted application 40 may then say, “Got it, would you like me to text a list of groceries to your phone and email you the recipe?” The subscriber may then respond with, “Yes,” after which the hosted application 40 may send a grocery list and recipe to the subscriber communication device 20, such as the subscriber's smartphone or other device as determined by the subscriber. The hosted application 40 may then say, “Grocery list and recipe sent.”

At step 220, the hosted application 40 may determine if there is information available on the Internet or some other information source from which the hosted application 40 may access that may be helpful to the subscriber based on the discussion or conversation the hosted application 40 had with the subscriber at step 210. For example, using the example described above, because the hosted application 40 has just had a discussion with the subscriber about a “chicken dinner,” the hosted application 40 may take the action to search the Internet for coupons related to chicken and send them to the subscriber's subscriber communication device 20 at step 230. As another example, the hosted application 40 may search the Internet for information on a wine or side dish that complements chicken marsala and send that information to the subscriber's subscriber communication device 20.

As another example according to embodiments of the present invention, the hosted application 40 may forward advertisements to the subscriber via the subscriber communication device 40. In addition, such advertisements may be related to content the subscriber has been listening to or may be based on a conversation or discussion the hosted application 40 has had with the subscriber. Using the example described above, because the hosted application is aware that the subscriber was interested in having an Italian dinner, the hosted application 40 may determine what Italian restaurants are in the vicinity of the subscriber and may send any information found by the hosted application 40 on the network 45 that may be valuable to the subscriber to the subscriber communication device 20, such as, for example, menus, restaurant reviews, and the like.

For example, if the subscriber is driving in the subscriber's car and happens to be near an Italian restaurant, the hosted application 40 determine the proximity of the subscriber to the Italian restaurant using location information available to the hosted application 40 through the subscriber communication device 20. For example, the subscriber communication device 20 may be equipped with a GPS system or other location identifying system and may make this information available to the hosted application 40. Then, the hosted application 40 may contact the subscriber communication device 20 via the network 45 and network adapter 30 and say to the subscriber, “Just to let you know, there is an Italian restaurant approximately two miles ahead on the right. The restaurant is offering a dinner special for chicken marsala tonight. Would you like to go there for dinner instead of cooking tonight?” The subscriber may respond by saying “yes” or “no.” If the subscriber says “no,” the hosted application 40 may be configured such that it either ends the dialog with the subscriber or the hosted application 40 may search for other advertisements or content to send to the subscriber. If the subscriber says “yes,” the hosted application 40 may guide the subscriber to the restaurant or take some other action that would be helpful to the subscriber, such as, for example, connecting the subscriber to the restaurant or making reservations at the restaurant for the subscriber.

As another example according to an embodiment of the present invention, a subscriber may initiate a call using the subscriber communication device 20 and may give the subscriber communication device 20 a predetermined command that causes the network adapter 30 to direct the call to the hosted application 40. Once the subscriber is in communication with the hosted application 40, the subscriber may say something like “Order pizza” or may give a similar command. The hosted application 40 may respond by saying, “What kind of pizza would you like?” The subscriber may then say, for example, “I'd like pepperoni, mushrooms and black olives.” The hosted application 40 may then, for example, respond with “When would you like it delivered?” The subscriber may then say, “I'd like the pizza delivered in 45 minutes.” The hosted application 40 may then respond with “Do you want me to order from the usual place or search for local coupons on the web?” The subscriber may then say, “Search for coupons on the web.”

After receiving the command to search for coupons on the web, the hosted application 40 may then search on the network 45 for coupons, discounts or other information that may be available to the subscriber. If, for example, the hosted application 40 should happen to find a coupon for pizza, the hosted application 40 may announce to the subscriber, “Coupon found for fifty percent off, would you like to apply this coupon to your order?” The subscriber may then say, “Yes.” In response, for example, the hosted application 40 may say “Thank you, your order has been submitted—goodbye” or may respond with some other statement or take some other action that would be appropriate for the circumstances.

While particular embodiments of the present invention have been shown and described, it will be obvious to those skilled in the art that the invention is not limited to the particular embodiments shown and described and that changes and modifications may be made without departing from the spirit and scope of the appended claims.

What is claimed is:

1. A method for voice operated communication assistance comprising:
detecting a predetermined command from a first user making a call on a communication device;
redirecting the call to a hosted application; and
notifying the first user that the hosted application is ready to accept a command.

2. The method of claim 1, further comprising:
receiving data from a second user; and
converting the data from the second user to a voice signal and sending the voice signal to the first user.

3. The method of claim 1, wherein the command is a voice command.

4. The method of claim 3, wherein the voice command directs the hosted application to assist the user with communication.

5. The method of claim 2, wherein the data is a text message.

6. The method of claim 1, further comprising loading information into the hosted application, wherein the information is associated with the user.

7. The method of claim 2, wherein the information includes social network information related to the user.

8. A system for voice operated communication assistance comprising:
a network adapter for detecting a predetermined command from a user making a call on a communication device; and
a hosted application for receiving the call,
wherein the network adapter redirects the call to the hosted application, and
wherein the hosted application notifies the user that the hosted application is ready to accept a voice operated communication assistance command.

9. The system of claim 8, wherein the predetermined command is a voice command.

10. The system of claim 8, wherein the communication device is a mobile telephone.

11. The system of claim 8, wherein the communication device is an analog telephone.

12. The system of claim 8, wherein the hosted application is configured to assist the user with communication.

13. The system of claim 8, wherein the hosted application is configured to deliver a text message to the user.
